(19) United States
(12) Patent Application Publication
(10) Pub. No.: US 2004/0003377 A1
(43) Pub. Date: Jan. 1, 2004

(54) Converting byte code instructions to a new instruction set

(76) Inventor: Michael A. Di Loreto, Tres Pinos, CA (US)

Correspondence Address: HEWLETT-PACKARD COMPANY, Intellectual Property Administration, P.O. Box 272400, Fort Collins, CO, 80527-2400, US

(21) Appl. No.: 10/185,286

(22) Filed: Jun. 28, 2002

(51) Int. Cl. G06F 9/45

(52) U.S. Cl. 717/136

(57) ABSTRACT

Byte code instructions encoding a computer method typically make use of a stack frame having an (implicit) stack pointer which points to locations on the stack frame for obtaining or storing data. Thus, the instructions typically do not contain an explicit encoding of locations on the stack frame for obtaining or storing data. The stack pointer typically adjusts itself automatically as data are moved on and off the stack frame during execution or simulation of a method.

In an improved methodology, before execution (JIT compilation or interpretation), various locations on the stack frame indicated by the stack pointer are converted into explicit location data on the stack frame, thereby obviating the need for the stack pointer. The byte code instructions are converted to new instructions using said explicit locations, and which are substantially uniform in size to improve efficiency of execution.

### BACKGROUND

Computer programs are typically written in human readable computer code (e.g., source code). The source code generally has to be compiled into native machine code to be executable via native hardware at a computer platform. Compilation is a process of translating computer code from one format (e.g., source code) to another format (e.g., native machine code).

Computer programs written in certain two-stage programming languages, such as the Java programming language, are typically first compiled from source code into intermediate code (i.e., Java byte code instructions). The intermediate code may be directly executed via an interpreter, and/or compiled into native machine code via a second compiler and then executed. Typically, in the latter case, the compiled native machine code may also be stored in memory for future reuse if the computer program is called again.

The foregoing interpretation and execution of intermediate code and/or compilation of intermediate code into native machine code is performed via a so-called “virtual processor.” The virtual processor is typically software installed on a computer platform, but may also be implemented in hardware or a combination of software and hardware. Intermediate code is generally platform independent and may be portable to multiple computer platforms having a compatible virtual processor.

A virtual processor for the Java programming language is generally referred to as the Java Virtual Machine (JVM) (e.g., a commercially available package called the Java Development Kit (JDK) 1.X provided by Sun Microsystems, Inc.). Typically, the JVM comprises several modules, namely, a Java compiler, a Java interpreter, and/or a Just-In-Time compiler (JIT). Alternatively, the Java compiler may be a separate module from the JVM. Technical specifications for implementing a JVM are well known to those skilled in the art and need not be described in detail here. See for example, T. Lindholm and F. Yellin, “The Java Virtual Machine Specification,” Addison Wesley, 1999, second edition, which is hereby incorporated by reference for all purposes.

The Java compiler, whether or not a part of the JVM, generally functions to compile Java source code into Java byte code instructions. The Java interpreter generally functions to interpret and execute the byte code instructions. The JIT generally functions to compile the byte code instructions into native machine code, such that native hardware at a computer platform may execute the native machine code.

Generally, the first time a compiled Java program (or a so-called Java method) is invoked, its byte code instructions are either interpreted and executed by the Java interpreter during runtime, or compiled into native machine code by the JIT. In the latter case, the native machine code may be executed via native hardware of the computer platform. The native machine code may also be stored in memory. Thus, the next time the same method is invoked, its native machine code may be retrieved directly from memory and executed.

Typically, the time from which a Java method is invoked to the execution of the method is shorter if the associated byte code instructions have already been translated into native machine code and stored in memory. Thus, the JIT may be preferred for programs that are likely to be reused, when faster execution is desired, and when memory resources for storage of the translated native machine code are available.

A typical byte code instruction has two fields, namely, an operation code (opcode) field and an operand (or argument) field. The opcode contains the operation to be performed and (in many contemporary systems) is generally 1 byte in size, thus, the name “byte” code instruction. The opcode may or may not be followed by an operand, which generally contains information regarding a value or an object to be operated upon in accordance with the operation called for in the opcode. An exemplary JVM instruction set and various types of opcode are well known to those skilled in the art and need not be described in detail here. See, for example, Chapters 6 and 9 of “The Java Virtual Machine Specification.”

The operand, if available, may be of variable size. For example, in many contemporary systems, the operand is typically between 1-2 bytes in size. Thus, byte code instructions in a typical method are generally not uniform in size (e.g., typically ranging from 1 to 3 bytes). Instructions of variable size are generally less efficient to compile into native machine code than instructions that are relatively uniform in size.

During execution of a Java method, memory space is typically set apart in the form of a stack frame to be used by the method. The stack frame generally comprises two components that hold data accessible by the method. These components are: (1) local variables; and (2) the operand stack. In many contemporary systems, the local variables and the operand stack typically each comprises a fixed number of 32 bit words on the stack frame.

Local variables are generally numerical values or references to objects that are to be used by a given method. Generally, a fixed-sized block of memory on the stack frame is set aside for storing local variables when a method is invoked. This block of memory may contain memory slots (e.g., 32-bit word slots) for storing local variables. Typically, local variables are accessed by byte code instructions via a number that has been assigned to each local variable. However, the location of each local variable on the stack frame is generally not explicitly encoded in the byte code instructions.

The operand stack typically comprises a number of words (e.g., 32 bit words) on the stack frame that may be used as work space during execution of a method. For example, when executing an “iadd” byte code instruction, two integers are added together. The JVM may assume that the integers to be added are the top two words on the operand stack that were pushed there by some previous instructions. Typically, the integers are popped from the stack, added, and their sum is pushed back onto the top of the operand stack.

Generally, a (implied) stack pointer to the stack frame is maintained by the JVM during execution of a method. For example, during execution of a method, the stack pointer generally points to various locations on the stack frame where each instruction of the method being executed may obtain data from or store data to the stack frame. Thus, byte code instructions that access the stack frame generally do not contain an explicit encoding of locations on the stack frame for obtaining or storing data. The stack pointer typically adjusts itself automatically as data are moved on and off of the stack frame (e.g., from a local variable to the operand stack, etc.) during execution or simulation of a method.

When byte code instructions in a method are compiled into native machine code by a JIT, if the various locations on the stack frame indicated by a stack pointer during execution of a method could be converted and/or encoded into native machine code, then the computer platform would be able to automatically locate data needed from the stack frame without necessarily maintaining such a pointer, thus, conserving computing resources.

Thus, it is desirable to convert byte code instructions into a new instruction set that is relatively uniform in size and/or may explicitly provide the location of data on the stack frame. Of course, various embodiments described herein do not strictly exclude the use of a stack pointer, but merely eliminate the necessity of using a stack pointer. For example, a stack pointer could still be used for redundancy or for some other purpose.

### SUMMARY

A process for converting byte code instructions to a new instruction set that is more efficiently compiled comprises: (a) obtaining an existing series of instructions for a computer method, the instructions not being all of the same width and at least some of the instructions accessing a memory space for the computer method in the form of a stack frame; (b) converting the existing instructions to a new set of instructions, where the new instructions being of substantially uniform width and each new instruction including (A) an opcode field, (B) an operand field, (C) a source field, and (D) a destination field; and (c) writing the new instructions to a computer-readable medium.

In an exemplary embodiment, where each existing instruction includes an opcode and an operand and the existing opcode is copied to a new opcode, the existing operand is translated to the new operand. Further, if the existing instruction references to a stack frame for source or destination data, a corresponding field in the new instruction is written with an explicit location on the stack frame for such data.

### BRIEF DESCRIPTION OF THE FIGURES

FIG. 1 illustrates a block diagram of an exemplary operating environment.

FIG. 2 illustrates a flow chart of an exemplary process for converting byte code instructions into a new instruction set.

FIG. 3 illustrates an exemplary table of flags that may be used in the new instruction set.

### DETAILED DESCRIPTION

I. Overview

Exemplary ways of converting byte code instructions of a method to a new instruction set are described herein. The new instruction set may comprise instructions that are relatively uniform in size and/or provide explicit locations of data on a stack frame for the method. In many cases, the new instruction set may be more efficiently compiled into native machine code as compared to the byte code instructions.

In particular, Section II describes an exemplary operating environment, Section III describes an exemplary embodiment for converting byte code instructions of a method into a new instruction set, and Section IV describes additional aspects and/or embodiments based on the exemplary embodiment of Section III.

II. An Exemplary Operating Environment

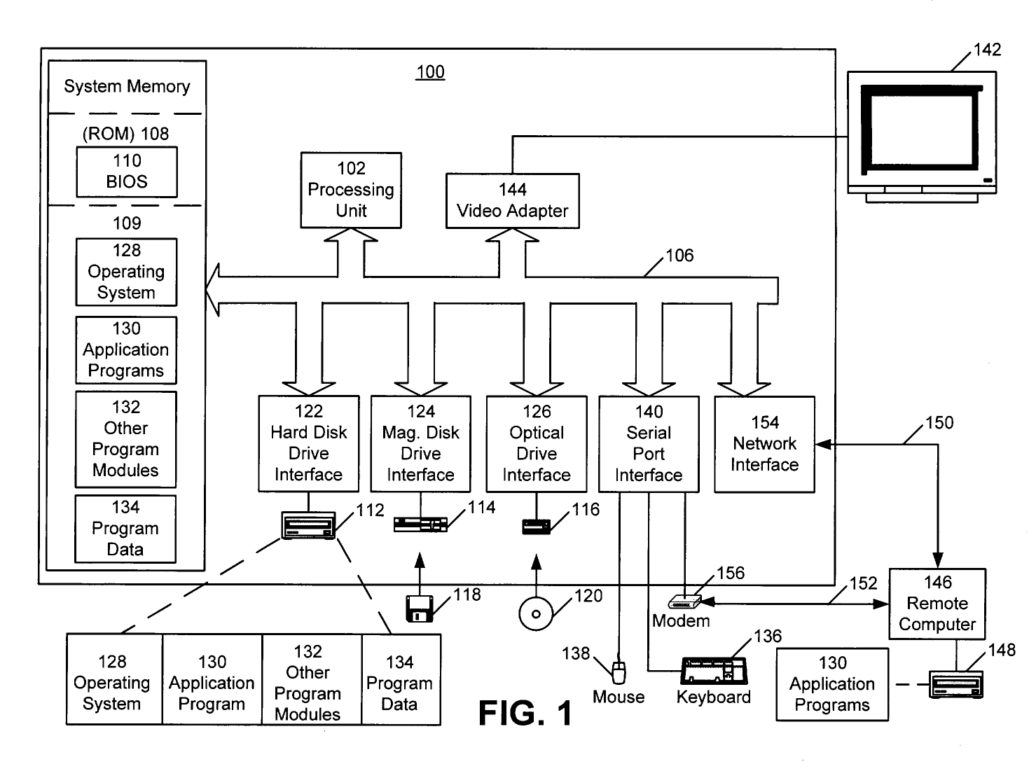

FIG. 1 is a block diagram of an exemplary operating environment. The description of FIG. 1 is intended to provide a brief, general description of one common type of computer hardware and computing environment in conjunction with which the various exemplary embodiments described herein may be implemented. Of course, other types of operating environments may be used as well.

Moreover, those skilled in the art will appreciate that other computer system configurations, including hand-held devices, multiprocessor systems, microprocessor-based or programmable consumer electronics, network PCs, minicomputers, mainframe computers, and the like may be implemented. Further, various embodiments described herein may also be practiced in distributed computing environments where tasks are performed by remote processing devices that are linked through a communications network. In a distributed computing environment, program modules may be located in both local and remote memory storage devices. Generally, the terms program, code, module, software, and other related terms as used herein may include routines, programs, objects, components, data structures, etc., that perform particular tasks or implement particular abstract data types.

The exemplary hardware and operating environment of FIG. 1 includes a general purpose computing device in the form of a computer 100. The computer includes a processing unit 102, a system memory 104, and a system bus 106 that operatively couples various system components, including the system memory 104, to the processing unit 102. There may be one or more processing units 102, such that the processor of computer 100 comprises a single central-processing unit (CPU), or a plurality of processing units, commonly referred to as a parallel processing environment. The computer 100 may be a conventional computer, a distributed computer, or any other type of computing device.

The system bus 106 may be any of several types of bus structures, including a memory bus or memory controller, a peripheral bus, a local bus using any of a variety of bus architectures, etc. The system memory 104 may also be referred to as simply the memory, and may include read only memory (ROM) 108, random access memory (RAM) 109, and/or other types of memory. In an exemplary embodiment, a basic input/output system (BIOS) 110, containing the basic routines that help to transfer information between elements within the computer 100, such as basic routines during start-up, may be stored in the ROM 108.

The computer 100 further includes a hard disk drive 112 for reading from and writing to a hard disk (not shown), a magnetic disk drive 114 for reading from or writing to a removable magnetic disk 118, an optical disk drive 116 for reading from or writing to a removable optical disk 120 (e.g., a CD ROM), and/or other disk and media types. The hard disk drive 112, magnetic disk drive 114, and optical disk drive 116 may be connected to the system bus 106 by a hard disk drive interface 122, a magnetic disk drive interface 124, and/or an optical disk drive interface 126, respectively. The drives and their associated computer-readable media may provide nonvolatile storage of computer-readable instructions, data structures, program modules and other data for the computer 100. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 118, optical disk 120, ROM 108, and/or RAM 109. Exemplary program modules include an operating system 128, one or more application programs 130, other program modules 132, and/or program data 134.

A user may enter commands and information into the computer 100 through input devices such as a keyboard 136 and/or a pointing device 138. Other input devices (not shown) may include a microphone, joystick, game pad, satellite dish, scanner, and/or other devices. Input devices are often connected to the processing unit 102 through a serial port interface 140 that is coupled to the system bus 106. Alternatively, input devices may be connected by other interfaces, such as a parallel port, game port, a universal serial bus (USB), etc. A monitor 142 or other type of display device may also be connected to the system bus 106 via an interface, such as a video adapter 144. Alternatively, or in addition to the monitor 142, computer 100 may include other peripheral output devices, such as speakers and printers (not shown).

The computer 100 may operate in a networked environment using logical connections to one or more remote computers, such as remote computer 146. These logical connections may be achieved by a communication device coupled to a part of the computer 100. The remote computer 146 may be another computer, a server, a router, a network PC, a client, a peer device, and/or other common network node, and may include some or all of the elements described above in relation to the computer 100. The exemplary logical connections depicted in FIG. 1 include a local-area network (LAN) 150 and/or a wide-area network (WAN) 152. Such networking environments are commonplace in offices, enterprise-wide computer networks, intranets and the Internet.

When used in a LAN-networking environment, the computer 100 may be connected to the local network 150 through a network interface or adapter 1156, which is a type of communications device. When used in a WAN-networking environment, the computer 100 may include a modem 156, and/or any other type of communications device for establishing communications over the wide area network 152, such as the Internet. In an exemplary embodiment, the modem 156, which may be internal or external, is connected to the system bus 106 via the serial port interface 140. In a networked environment, program modules depicted relative to the personal computer 100, or portions thereof, may be stored in the remote memory storage device 148. It is appreciated that the network configuration shown is merely exemplary, and that other technologies for establishing a communications link between the computers may also be used.

III. An Exemplary Process for Converting Byte Code Instructions

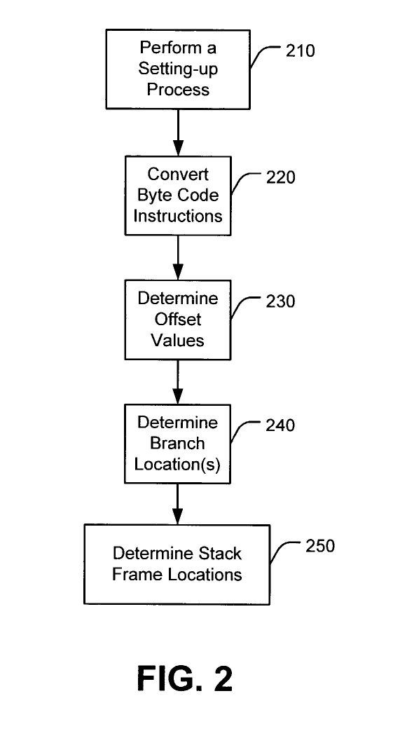

FIG. 2 illustrates an exemplary process for converting byte code instructions of a method into a new instruction set. At step 210, if necessary, a setting up process may be performed to allocate memory space for storing the new instruction set and/or other information. In an exemplary embodiment, the setting up process includes allocating a first memory array for storing a new instruction set and allocating a second memory array for storing an offset index for use during the conversion process. At step 220, one or more byte code instructions are converted into new instructions. In one embodiment, each byte code instruction is converted into one or more new instructions. For example, the opcode and operand fields of each byte code instruction may be represented in corresponding fields of the one or more new instructions. Additional aspects and/or embodiments for converting byte code instructions into the new instruction set will be described in more detail in Section IV below.

At step 230, offset values for the new instructions are determined. In an exemplary embodiment, the offset value for each new instruction may be determined based the new instruction's relative position and/or the corresponding byte code instruction's relative position in the method. For example, the offset value for an instruction may be determined by counting the number of bytes from the top of the method to that instruction. This would be appropriate where, for example, each instruction occupies a relative memory space from the top of the method (i.e., the first instruction of the method). Of course, one skilled in the art may readily appreciate that offset values may also be determined based on other reference points. Additional aspects and/or exemplary embodiments for determining offset values will be described in more detail in Section IV below.

At step 240, the branch location(s) are determined for one or more branch instructions (if any) in the new instruction set. In an exemplary embodiment, branch locations are determined based on offset values determined in the previous step, and the branch location for each branch instruction is stored in the first memory array. Additional aspects and/or exemplary embodiments for determining branch locations will be described in more detail in Section IV below.

At step 250, word numbers indicating locations on the stack frame (e.g., locations of local variables and locations on the operand stack) are determined for one or more instructions in the new instruction set. In an exemplary embodiment, the word numbers may be determined by simulating the method, and the word numbers are stored in the first memory array. Additional aspects and/or exemplary embodiments for determining such word numbers will be described in more detail in Section IV below.

The new instruction set is written to computer-readable media (as was done for the byte code instructions), and from there can be executed via an interpreter, or via a JIT. Indeed, the process for converting existing byte code instructions to a new instruction set could even be implemented within a JIT, for on-the-fly operation.

The processes disclosed herein are typically implemented as software installed on a computer platform, but may also be implemented in hardware or a combination of software and hardware. The software could be stored and accessed from a variety of computer-readable media including, without limitation, a hard disk, a CD, RAM (of all types), and still other electronic, magnetic and/or optical media known to those skilled in the art.

IV. Additional Aspects and/or Exemplary Embodiments

A. An Exemplary Setting-Up Process

1. Allocating the First Memory Array

In an exemplary setting-up process for converting byte code instructions of a method to a new instruction set, a first array of memory (“first memory array”) is allocated for storing the new instruction set. In one embodiment, the length of the first memory array may be substantially the same as the number of byte code instructions in the method. Further, the width of the first memory array is chosen to be large enough to store data to be converted from typical byte code instructions. For example, in an exemplary implementation appropriate for some contemporary systems, the width in the first memory array could be 64 bits (or 8 bytes) in size.

2. Allocating the Second Memory Array

In an exemplary setting up process, a second array of memory (“second memory array”) is also allocated, and is used for storing offset values of the new instructions. In one embodiment, the length of the second memory array may be substantially the same as the number of byte code instructions in the method. Further, the width of the second memory array is chosen to be large enough to accommodate potential offset values. For example, the maximum offset value for a method may be the total number of bytes in the method. In an exemplary implementation appropriate for some contemporary systems, the second memory array could be an integer array, having a width of 32 bits.

B. An Exemplary Process for Populating the First and Second Memory Arrays

1. Populating the First Memory Array

In an exemplary embodiment, for each byte code instruction, one or more corresponding new instructions are created in the first memory array. Further, the memory space for each new instruction may be logically partitioned into multiple fields for storing different types of information. For example, a new instruction may include one or more of operation code field, an operand field, a source field, a destination field, and a flag field.

The operation code field and the operand field in a new instruction may contain data that were in the corresponding fields of the corresponding byte code instruction, respectively. For example, in an exemplary implementation appropriate for some contemporary systems, the operation code field could be 8 bits (or 1 byte) and the operand field could be 16 bits (or 2 bytes). In another aspect, if the operand field in a byte code instruction is larger than the allocated memory space in the new instruction, other unused fields (e.g., source, destination, or flag fields, etc.) in the new instruction may be used to store the extra operand data. Alternatively, or in combination, memory space for a new instruction may be used to store the extra operand data.

In an exemplary embodiment, the source field and the destination field, if used, may indicate stack frame locations. More specifically, the source field may provide a location from which to obtain data. For example, the source field might include a word number indicating a location of a local variable or a location on the operand stack from which to obtain data. In an exemplary implementation appropriate for some contemporary systems, the source field could be 16 bits (or 2 bytes) in size. Additional description about the source field is provided in Section IV.D below.

In an exemplary embodiment, the destination field may include a destination location on the stack frame. For example, the destination field may include a word number indicating a location of a local variable or a location on the operand stack to store data. In an exemplary implementation appropriate for some contemporary systems, the destination field could be 16 bits (or 2 bytes) in size. Additional description about the destination field is provided in Section IV.D below.

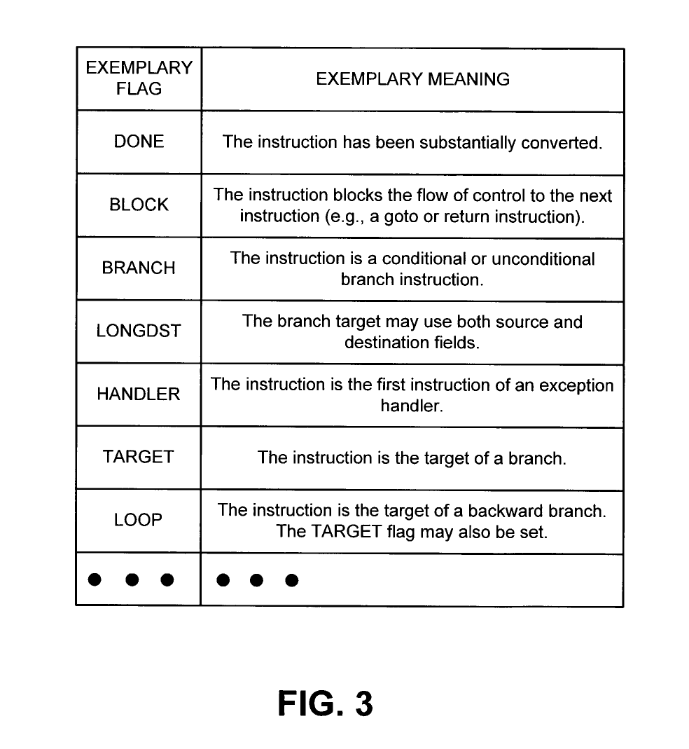

In an exemplary embodiment, the flag field typically includes a flag value that may be used during the conversion process or during the execution of the method. In an exemplary implementation appropriate for some contemporary systems, the flag field could be 8 bits (or 1 byte). A table containing exemplary flag fields and their corresponding meanings is set forth in FIG. 3. More description about FIG. 3 is provided in Section IV.G below.

2. Populating the Second Memory Array

An offset value is typically specified based on the relative memory locations between or among instructions of a method. For example, when a branch instruction (e.g., a goto instruction) is encountered during execution of a method, an offset value referenced by the branch instruction is used to jump to the correct branch location to continue execution of the method.

When byte code instructions are converted to a new instruction set, new offset values for the new instructions may be determined, particularly if the corresponding byte code instructions are not of substantially the same size as the new instructions. Such may be the case because byte code instructions are typically variable in size (e.g., 1-3 bytes each) and the new instructions are relatively fixed in size (e.g., 8 bytes each). Thus, the offset values among byte code instructions may be different than the offset values among the new instructions.

For example, assume that a first byte code instruction has 2 bytes, a second byte code instruction has 1 byte, a third byte code instruction has 2 bytes, and a fourth byte code instruction is a branch instruction that calls the third instruction. In this example, the fourth byte code instruction refers to an offset value of 3 bytes, indicating the branch location where the called third instruction begins (calculated from the top of the method). In the same example, corresponding new instructions could each have 8 bytes. Thus, the fourth new instruction may refer to and/or include an offset value of 16 bytes, indicating the branch location where the called third instruction begins (also calculated from the top of the method).

C. An Exemplary Process for Determining the Branch Location(s) for Branch Instructions

Where one or more instructions in the method are branch instructions (e.g., a goto instruction), the branch locations for the branch instructions may be determined.

In one embodiment, offset values stored in the second memory array may be used as an index to determine the branch locations. For example, a target instruction's (i.e., the instruction branched to) offset value and the current instruction's (i.e., the instruction branched from) offset value may be determined based on the offset values stored in the second memory array for the instructions. Next, the current offset value may be subtracted from the target offset value. In this example, the resulting difference may determine the branch location. In one embodiment, the resulting difference may be encoded in the destination field of the branch instruction.

For example, assume the tenth new instruction is a goto instruction to go to the fourteenth instruction. Further assume that each new instruction is 8 bytes in size. Thus, the fourteenth instruction has an offset value of 104 bytes and tenth instruction has an offset value of 72 bytes, relative to the top of the method. In this example, the branch location is equal to +32 bytes (104 bytes minus 72 bytes). That is, to get to the branch location, 32 bytes are added to the tenth instruction's offset value (of 72 bytes). In one embodiment, the +32 bytes may be encoded in the destination field of tenth instruction.

D. An Exemplary Process for Determining Stack Frame Locations

In an exemplary embodiment, a simulation of the method may be performed to determine word numbers for stack frame locations. In particular, a stack pointer is used to determine the stack frame locations that may be encoded into the new instructions.

For example, if a byte code instruction is an “iadd” instruction (i.e., to add two integers), typically, the stack pointer would initially point to the top two values on the operand stack. Generally, the execution of the iadd instruction includes popping the top two values off of the operand stack, adding the two values, then pushing the sum back onto the top of the operand stack. Thus, when the instruction has been executed, the stack pointer will again point to the top of the operand stack, where the sum is now stored. A corresponding new instruction might encode the stack frame locations (e.g., locations on the operand stack) explicitly in the instruction (e.g., via word numbers of the locations on the stack frame in the source and/or destination fields, as necessary) and render the stack pointer unnecessary. In this example, the source field of the new instruction would include the word number of the top of the operand stack relative to the stack frame and the destination field of the new instruction would include the word number of the next location on the operand stack relative to the stack frame where the sum should be pushed.

As another example, if a byte code instruction is a load instruction (i.e., to retrieve the contents of a local variable and push them onto the operand stack), generally, a local variable to be loaded is referenced by the byte code instruction via the local variable's assigned number. The execution of a load instruction would include retrieving the contents of the local variable and pushing the contents onto the top of the operand stack. Thus, when the instruction has been executed, the stack pointer will point to the top of the operand stack, where the contents are now loaded. A corresponding new instruction might encode the stack frame locations explicitly in the instruction. In this example, the source field of the instruction would include a word number of the local variable relative to the stack frame and the destination field of the instruction would include the word number of the top of the operand stack relative to the stack frame.

As yet another example, if a byte code instruction is a store instruction (i.e., to pop the value off of the top of the operand stack and store the value into a local variable), the stack pointer may initially point to the top of the operand stack. Generally, the execution of a store instruction includes popping the value on the top of the operand stack and storing the value in a local variable. The local variable for storing the value is referenced by the byte code instruction via the local variable's assigned number. When the instruction has been executed, the stack pointer will again point to the top of the operand stack. A corresponding new instruction might encode the stack frame locations explicitly in the instruction. In this example, the source field of the instruction would include the word number of the top of the operand stack relative to the stack frame and the destination field of the instruction would include a word number of the location of the local variable relative to the stack frame.

The processes described above are merely exemplary, and their corresponding examples are merely illustrative. Those skilled in the art will appreciate that still other forms of encoding stack frame locations may be used according to the requirements of a particular implementation.

E. Other Exemplary Processes

1. The Exception Table

A method may refer to an exception table for handling exceptions. For example, if an exception in a method calls a byte code instruction within the method, the entry for the exception in the exception table may include an offset value to that byte code instruction. In an exemplary embodiment, if the method being converted has an exception table, offset values in that exception table may be modified as part of conversion to the new instruction set.

In one embodiment, the offset values in an exception table may be modified to reflect the offset values relative to the new instructions. In another embodiment, the exception table may be copied and the offset values may only be modified in the copied exception table. The location of the copied exception table may be referenced in a method information section for the new instruction set.

In an exemplary embodiment, offset values stored in the second memory array may be used for determining the new offset values in the exception table.

2. The Line Number Table

A method being converted may also refer to a line number table. Generally, a line number table, if available, may be used for debugging purposes. A line number table typically provides an association between each line of source code and the corresponding byte code instruction(s) of the method. Typically, in an exemplary line number table, the associated byte code instructions to each line of source code are referred to by their respective offset values relative to the top of the method.

In one embodiment, the offset values in a line number table may be modified to reflect the offset values relative to the new instructions. In another embodiment, the line number table may be copied and the offset values may only be modified in the copied line number table. The location of the copied line number table may be referenced in a method information section for the new instruction set.

In an exemplary embodiment, offset values stored in the second memory array may be used for determining the new offset values in the line number table.

F. Exemplary Clean Up Processes

In an exemplary embodiment, the memory space occupied by the first memory array may be adjusted to the actual size of the new instruction set. For example, if more than enough memory space was allocated, when the conversion is completed, any unused memory resources may be re-allocated.

In another exemplary embodiment, the memory space occupied by the second memory array may be released after the method has been converted to the new instruction set.

These clean up processes are merely exemplary. Those skilled in the art will appreciate that still other forms of garbage collection and/or clean up processes may also be used accordingly to the requirements of a particular implementation.

G. The Flag Table

FIG. 3 illustrates a table including some exemplary flags that may be encoded into the new instruction set. For example, a flag may indicate the status of an instruction. The status information may be used during the conversion process described above, during execution of the native machine code (after the new instruction set has been compiled by a JIT), and/or for other purposes.

The flags illustrated in FIG. 3 are merely exemplary. Those skilled in the art will appreciate that still other flags and/or definitions may also be used accordingly to the requirements of a particular implementation.

V. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims.

What is claimed is:

1. A process for converting byte code instructions to a new instruction set that is more efficiently compiled, comprising:
(a) obtaining an existing series of instructions for a computer method;
(i) said instructions not being all of the same width;
(ii) each said instruction including an opcode and an operand;
(iii) at least some of said instructions accessing a memory space for said computer method in the form of a stack frame;
(b) converting said existing instructions to a new set of instructions;
(i) said new instructions being of substantially uniform width;
(ii) each said new instruction including (A) an opcode field, (B) an operand field, (C) a source field, and (D) a destination field;
(iii) for each existing instruction and its corresponding new instruction:
(A) copying said existing opcode to a new opcode;
(B) translating said existing operand to said new operand;
(C) if said existing instruction references said stack frame for source or destination data, writing a corresponding field in said new instruction with an explicit location on said stack frame for such data; and
(c) writing said new instructions to a computer-readable medium.

2. The process of claim 1 where said explicit location includes a word number of said location on said stack frame.

3. The process of claim 2 where, for at least one instruction type, said word number corresponds to a top of an operand stack in said stack frame.

4. The process of claim 2 where said word number corresponds to a local variable in said stack frame.

5. The process of claim 2 further comprising determining said word numbers by simulating said method encoded by said existing instructions.

6. The process of claim 1 where said translating in said (b)(iii)(B) includes copying said existing operand for a non-branch opcode.

7. The process of claim 1 where:
(i) a second of said existing instructions includes an existing offset value relative to a first of said existing instructions;
(ii) said first and second existing instructions have corresponding first and second new instructions;
(iii) said translating in said (b)(iii)(B) includes arithmetically adjusting said existing offset value to a new offset value;
(iv) said adjusting accounting for a difference in a number of bytes between the first and second instructions, in the new instructions relative to the existing instructions.

8. The process of claim 7 where said second new instruction is a branch instruction branching to said first new instruction, said writing in said (b)(iii)(C) includes calculating a branch location based on said new offset value.

9. The process of claim 1:
(x) where said new instructions further comprise a flag field; and
(y) further comprising writing said flag field for at least some of said instructions to indicate a status of said converting in (b).

10. The process of claim 1 where, for at least one of said new instructions:
(x) said existing operand field is larger than said new operand field; and
(y) further comprising using another of said new fields in said new instruction, besides said new operand field, for storing a portion of said existing operand.

11. The process of claim 1 where, for at least one of said new instructions:
(x) said existing operand field is larger than said new operand field; and
(y) further comprising using memory space for a different new instruction, for storing a portion of said existing operand.

12. The process of claim 1 where:
(i) at least one of said new instructions is an integer add instruction; and
(ii) for said add instruction, said explicit location for said source and destination fields includes a word number of the top of an operand stack used by said add instruction.

13. The process of claim 1 where:
(i) at least one of said new instructions is a load instruction; and
(ii) for said load instruction, said explicit location for said source field includes a word number of a local variable used by said load instruction; and
(iii) for said load instruction, said explicit location for said destination field includes a word number of the top of an operand stack used by said load instruction.

14. The process of claim 1 where:
(i) at least one of said new instructions is a store instruction; and
(ii) for said store instruction, said explicit location for said destination field includes a word number of a local variable used by said store instruction; and
(iii) for said store instruction, said explicit location for said source field includes a word number of the top of an operand stack used by said store instruction.

15. The process of claim 1 where:
(i) said computer method includes a table having offset values; and
(ii) further comprising modifying said offset values to account for size differences of said new instructions relative to said existing instructions.

16. The process of claim 1 implemented within a just-in-time compiler.

17. A computer readable medium for converting byte code instructions to a new instruction set that is more efficiently compiled, comprising logic instructions that, if executed:
(a) obtain an existing series of instructions for a computer method;
(i) said instructions not being all of the same width;
(ii) each said instruction including an opcode and an operand;
(iii) at least some of said instructions accessing a memory space for said computer method in the form of a stack frame;
(b) convert said existing instructions to a new set of instructions;
(i) said new instructions being of substantially uniform width;
(ii) each said new instruction including (A) an opcode field, (B) an operand field, (C) a source field, and (D) a destination field;
(iii) for each existing instruction and its corresponding new instruction:
(A) copy said existing opcode to a new opcode;
(B) translate said existing operand to said new operand;
(C) if said existing instruction references said stack frame for source or destination data, write a corresponding field in said new instruction with an explicit location on said stack frame for such data; and
(c) write said new instructions to a computer-readable medium.

18. The computer-readable medium of claim 17 where said explicit location includes a word number of said location on said stack frame.

19. The computer-readable medium of claim 18 further comprising logic instructions that, if executed, determine said word numbers by simulating said computer method encoded by said existing instructions.

20. The computer-readable medium of claim 17 where:
(i) a second of said existing instructions includes an existing offset value relative to a first of said existing instructions;
(ii) said first and second existing instructions have corresponding first and second new instructions;
(iii) said translation in said (b)(iii)(B) includes arithmetically adjusting said existing offset value to a new offset value;
(iv) said adjusting accounting for a difference in a number of bytes between the first and second instructions, in the new instructions relative to the existing instructions.

21. The computer-readable medium of claim 20 where said second new instruction is a branch instruction branching to said first new instruction, said writing in said (b)(iii)(C) includes calculating a branch location based on said new offset value.

22. The computer-readable medium of claim 17 where, for at least one of said instructions:
(x) said existing operand field is larger than said new operand field; and
(y) further comprising logic instructions that, if executed, use another of said new fields in said new instruction, besides said new operand field, to store a portion of said existing operand.

23. The computer-readable medium of claim 17 where, for at least one of said instructions:
(x) said existing operand field is larger than said new operand field; and
(y) further comprising logic instructions that, if executed, use memory space for a different new instruction, for storing a portion of said existing operand.

24. An apparatus for converting byte code instructions to a new instruction set that is more efficiently compiled, comprising:
(a) means for obtaining an existing series of instructions for a computer method;
(i) said instructions not being all of the same width;
(ii) each said instruction including an opcode and an operand;
(iii) at least some of said instructions accessing a memory space for said computer method in the form of a stack frame; and
(b) means for converting said existing instructions to a new set of instructions;
(i) said new instructions being of substantially uniform width;
(ii) each said new instruction including (A) an opcode field, (B) an operand field, (C) a source field, and (D) a destination field;
(iii) for each existing instruction and its corresponding new instruction, means for:
(A) copying said existing opcode to a new opcode;
(B) translating said existing operand to said new operand;
(C) if said existing instruction references said stack frame for source or destination data, writing a corresponding field in said new instruction with an explicit location on said stack frame for such data; and
(c) means for writing said new instructions to a computer-readable medium.

25. The apparatus of claim 24 further comprising means for determining said word numbers of said locations on said stack frame by simulating said method encoded by said instructions.

26. The apparatus of claim 24 where:
(i) a second of said existing instructions includes an existing offset value relative to a first of said existing instructions;
(ii) said first and second existing instructions have corresponding first and second new instructions;
(iii) said means for translating in said (b)(iii)(B) includes means for arithmetically adjusting said existing offset value to a new offset value;
(iv) said adjusting accounting for a difference in a number of bytes between the first and second instructions, in the new instructions relative to the existing instructions.

27. The apparatus of claim 26 where said second new instruction is a branch instruction branching to said first new instruction, said means for writing in said (b)(iii)(C) includes calculating a branch location based on said new offset value.

28. The apparatus of claim 24 implemented within a just-in-time compiler.

29. A process for converting byte code instructions to a new instruction set that is more efficiently compiled, comprising:
(a) receiving a set of byte code instructions encoding a computer method;
(i) said byte code instructions making use of a stack frame having an implicit stack pointer which points to locations on said stack frame for obtaining and storing data;
(ii) said stack pointer configured to adjust itself as data are moved on and off of said stack frame during execution of said method;
(b) converting various locations on the stack frame indicated by said stack pointer into explicit locations on the stack frame, thereby obviating the need for the stack pointer;
(c) converting said byte code instructions into new instructions (i) using said explicit locations and (ii) which are substantially uniform in size; and
(d) storing said new instructions for subsequent use during interpretation or just-in-time compilation.

30. A computer-readable medium for converting byte code instructions to a new instruction set that is more efficiently compiled, comprising logic instructions that, if executed:
(a) receive a set of byte code instructions encoding a computer method;
(i) said byte code instructions making use of a stack frame having an implicit stack pointer which points to locations on said stack frame for obtaining and storing data;
(ii) said stack pointer configured to adjust itself as data are moved on and off of said stack frame during execution of said method;
(b) convert various locations on the stack frame indicated by said stack pointer into explicit locations on the stack frame, thereby obviating the need for the stack pointer;
(c) convert said byte code instructions into new instructions (i) using said explicit locations and (ii) which are substantially uniform in size; and
(d) store said new instructions for subsequent use during interpretation or just-in-time compilation.
